(19) United States
(12) Patent Application Publication
(10) Pub. No.: US 2003/0124292 A1
(43) Pub. Date: Jul. 3, 2003

(54) Sealing or insulating sheeting made of ( polymer-) bitumen

(76) Inventor: Karl Unterreiter, Altmunster (AU)

Correspondence Address: John F McNulty, Paul & Paul, 2900 Two Thousand Market Street, Philadelphia, PA, 19103, US

(21) Appl. No.: 10/220,712

(22) PCT Filed: Mar. 1, 2001
(86) PCT No.: PCT/AT01/00056

(30) Foreign Application Priority Data
Mar. 3, 2000 (AT) A 351/2000

(51) Int. Cl. B32B 9/00

(52) U.S. Cl. 428/40.1; 428/43

(57) ABSTRACT

The invention relates to sealing or insulating sheeting made of (polymer-)bitumen, especially for covering roofs and lining external cellar walls, comprising at least one self-adhesive surface which is made of an adhesive material and which is provided at least over a portion of the surfaces of the sheeting. The or each self-adhesive surface is provided with a protective covering that can be peeled off. The inventive sheeting is characterized in that the protective covering (3) of at least one self-adhesive surface (2) is slit and/or perforated at one or more locations (4) and/or is provided in the form of several partially overlapping separation layer sheetings (3, 3′, 3″, 3′″), whereby portions of the protective covering (3) can be peeled off separately from one another along predefined lines.

The present invention relates to new sealing and/or insulating sheets made of (polymer) bitumen, more particularly for covering roofs and lining the external wall of cellars, as well as methods of laying such new sheets on the roofs and walls of buildings.

It is known that buildings require extensive sealing and insulation against external influences such as damp and cold. Roofs and cellars, especially the external walls of cellars, are particularly exposed to such influences, for which reason a variety of sealing and/or insulating sheets are used, such as, for example, vapour seals, vapour barriers, thermal insulation, equalising layers etc.

In this field, multiple-layer, unilaterally adhesive (“self-adhesive” or thermally activated, e.g. through “flaming”) roof sealing and/or insulating sheets made of polymer bitumen without intermediate layers (homogeneous) or with various intermediate layers and/or reinforcements (e.g. aluminium foil, glass fabric, glass screens, glass mats, plastic mats and combinations of these materials) as well as with different surfaces (e.g. non-detachable films, natural slate plates, coloured sand particles, fine sand, talcum) are generally familiar as such sheets according to the state of the art.

Also known are surfaces made of synthetic film (e.g. PE, PP), which, for example, serve as the substrate for subsequent (self-adhesive) sheets, or which through melting-on (e.g. with a naked flame or hot air) activate the adhesion of the underneath layer of the same sheet, thereby making possible an adhesive joint with the next layer of the entire construction (e.g. roof), such as, for example, thermal insulation, bitumen sheet etc.

The individual sealing and/or insulating sheets are usually deployed by unrolling the individual sheets, which after manufacture predominantly come rolled up on themselves in the form of rolls, onto the substrate, normally overlapping in relation to each other in order to avoid joints between the sheets, which would constitute potential problems areas. The extent of overlapping can, depending on the type and purpose of the sheet, range from a few centimetres to half the width of the sheet, but is preferably in the order of 8-12 cm.

In the case of the known self-adhesive sheets, the self-adhesive surface is normally provided on the underside, which after rolling up on itself forms the outside of the roll, in order to enable the rolls, when laying on roofs, for example, to be unrolled in a lying position and stuck to the substrate (e.g. concrete base or an underlying sheet or thermal insulation). The self-adhesive surface is provided with a continuous, uninterrupted covering (separation layer) made of (if necessary silicon-treated) paper, film or other easily detachable material to prevent the sheets from sticking in the roll, which is pulled off when working with the sheet at the building site, thereby exposing the self-adhesive surface.

In one piece and without any separation, the separation layer thus covers the entire width of the polymer bitumen sheet, which can be of various widths (but preferably 1 m), and its entire length.

Also known are sheets in which only the edge intended for overlapping is self-adhesive and covered over the preferred width (8-12 cm) with one of the aforementioned coverings.

Self-adhesive sheets are also known in which although the covering on the underside extends uninterruptedly over the entire width of the sheet, its adhesion to the sheet is only partial (e.g. in a, preferably longitudinal, direction or at various points on the underside).

In spite of the relatively good sealing and insulation performance of these sheets in accordance with the state of the art, they also have a number of drawbacks.

The principal problem lies in working with the sheets, as this is limited to certain external conditions. As has been stated above, the sealing and insulation coverings of, for example, roofs and the external walls of cellars, are applied (stuck on) in several layers, i.e. one layer of sheets after the other, which, depending on the size of the surface to be insulated, can sometimes take several days. In the case of roof coverings in particular, there is the problem that each laid sheet can become soiled, or wet in the case of unfavourable weather conditions, before the next layer is applied, which can result in impaired adhesion as well as sealing and/or insulating performance, e.g. the formation of bubbles between the layers.

For this reason sheet surfaces must be carefully cleaned and, if necessary, dried or left to dry, before applying the subsequent sheets, which involves additional working or waiting time, and thereby long laying times and higher costs.

Furthermore, the self-adhesive surfaces usually require a working temperature of at least 5° C., preferably at least 9-10° C., in order to guarantee sufficient adhesion without thermal activation being needed. With too low working temperatures, not only is the adhesive effect impaired during working, but the long-term adhesion and therefore under certain circumstances also the tightness of the adhesive joint also suffer, i.e. over the course of time micro-channels can form between mutually adhering surfaces, through which moisture can penetrate under the sealing sheet.

Finally a further problem lies in the fact that mutually adhering surfaces form heterogeneous interfaces, i.e. the materials of the adhesive surface of a sheet and the surface of sheet lying below it differ considerably from each other, which does not benefit the adhesive effect.

The aim of the invention is to eliminate the above problems by providing improved sheets for sealing and/or insulating buildings.

According to the invention, this aim is achieved by providing a sealing and/or insulating sheet made of (polymer) bitumen, which is particularly suitable for covering roofs and lining the external walls of cellars, and is provided with at least one self-adhesive surface on at least part of one of the surfaces of the sheet, whereby the at least one self-adhesive surfaces has a detachable protective covering for the self-adhesive surface, characterised in that the protective covering of at least one self-adhesive surface is, at one or more points, designed with slits and/or perforations and/or is weakened and/or in the form of several partially overlapping separation layer sheets, whereby parts of the protective covering can be detached from each other along predefined lines. In a preferred form of embodiment, the entire surface of a sealing and/or insulating sheet according to the invention is provided with a self-adhesive surface and covering layer.

In this way, after laying one layer of the present sheets, which—as has been mentioned—takes place with the sheets overlapping each other, the surface is optimally protected against dirt and moisture, as before applying the next layer the protective covering(s) only has/have to he removed in the overlap area, while the remainder of the protective covering(s) remain on the self-adhesive surfaces for the time being.

Therefore the protective layer does not only protect the self-adhesive surfaces from sticking to the other surface of the sheet when rolled up and against damage, but it also protects the layer surface after laying. In this way the laying process can be considerably simplified and accelerated, as the hitherto time-consuming cleaning and drying of the layer surfaces can largely been dispensed with before applying the next layer. This does not only save time and costs, but work can be continued in more unfavourable weather conditions than before.

Weaknesses at the appropriate points in the protective covering are either provided from the outset by way of folding, stamping or punching, or by way of pulling out threads or bands, made for example of plastic, metal or composite material, incorporated into the protective covering (3). With the latter form of embodiment unintentional removal of parts of the protective covering during storage is prevented, but the deliberate weaknesses can easily be applied to the protective covers on site.

Preferably the protective covering is longitudinally slit and/or perforated and/or weakened and/or designed in the form of several partially overlapping separation layer sheets at regular intervals over the entire width of the sheet. This increases flexibility when laying the sheets, as not only can the width of the overlaps be freely selected with a large number of separation points, but the sheet can be cut more easily and more precisely at the edge of the substrate (e.g. roof, external wall of cellar) along the separation points. Also, the cut-off sections of sheet remain covered with protective covering can be re-used more easily.

In a particularly preferred variant, the protective covering of the sheets in accordance with the invention are also slit and/or perforated and/or weakened and/or designed in the form of a partially overlapping separation layer sheet in the vicinity of at least one lateral edge, more particularly both lateral edges of the sheet in a lateral direction in order to implement “abutment”, i.e. the overlapping areas of the sheets in the case of head-to-head laying, as simply and with the same advantages as with overlapping in the longitudinal direction.

Preferably, in the case of the sealing and/or insulating sheets in accordance with the invention, the minimum distance between the slits or perforations or weaknesses and the nearest edges corresponds to the width of the overlaps formed when laying the sheets, in order to guarantee the mutual adhesion and tightness of the laid sheets.

In a particularly preferred embodiment of the invention, at least one of the protective coverings at the edge overlaps this edge in order to form a safety strip. The safety strip should preferably be in accordance with the following equation:

b≧d+(m−ü)

where

b: width of the safety strip

d: thickness of the sheet

m: minimum distance between the next slit(s) and perforation(s) and or partial overlap(s) of individual separating layers and the edge

ü: width of the overlaps of the sheets when laying

With this type of safety strip, when laying the sheets in accordance with the invention, the hitherto exposed side areas of the sheets can remain protected against dirt and moisture. When laying a sheet, overlapping after pulling off the protective covering at the edge of the previous sheet does not take place over the entire exposed self-adhesive surface, but is slightly offset towards the edge, so that a strip of self-adhesive surface is not covered by the underside of the sheet. The safety strip above it is bent down over the edge and is stuck to this exposed self-adhesive area so that the lateral face of the sheet, and in turn the entire surface of all the sheets remain protected with protective covering. In the preferred embodiment the width of the safety strip thereby preferably corresponds to at least this exposed self-adhesive area, which is calculated by way of the above equation.

In addition, preferred sealing and/or insulating sheets also have, on at least part of the opposite surface, at least one self-adhesive area, including the associated protective covering(s), through which the adhesion of the (overlapping) sheets to each other is clearly improved compared to the case in which self-adhesive surface are supposed to adhere to non-self-adhesive (polymer) bitumen.

If the adhesive material of the self-adhesive areas on one surface of the sheets is the same as that of the self-adhesive areas on the opposite surface, whereby in contrast to the state of the art, in which heterogeneous interfaces, i.e. boundary areas between different materials, are formed between the sheets, the strength and durability of the adhesive bond can be maximised. With such particularly preferred sheets in accordance with the invention, homogenous interfaces are formed during laying, whereby instead of adhesion forces as in the state of the art, cohesion forces bring about the adhesive effect.

The protective coverings on the self-adhesive surfaces of the opposite surface of the sheet are also preferably the same as those of the first surface, i.e. slit and/or perforated and/or weakened and/or designed as partially overlapping individual sheets, more particularly at numerous points and at regular intervals, so as to allow the aforementioned laying advantages to come to the fore on both sides.

One variant of the sealing and/or insulating sheets in accordance with the invention envisages one or more surface modification(s) being provided on at least part of the opposite surface. In this way, instead of, or in addition to self-adhesive surfaces, modified (polymer) bitumen surfaces can also be provided, which prove to be particularly useful if the invented sheets are laid on concrete, for example, where self-adhesion would not be sufficiently effective, with the bitumen itself having to be heated and slightly melted in order to adhere to the substrate.

The surface modifications can be selected in the known manner from among non-detachable films, natural slate plates, coloured sand particles, find sand and talcum in order to provide the surface with properties, the advantages of which will be discussed in more detail below.

In another form of embodiment of the sealing and/or insulating sheets in accordance with the invention, at least part of the opposite surface of the sheet can be provided, preferably through bonding or fusing, with thermal insulation. This provides known combinations of sealing sheets and thermal insulation in the form of rolled sheets or (shorter sheets e.g. 3-5 m) folded sheets with the advantages of the invention, i.e. self-adhesion with subdivided protective covering on the surface.

The thermal insulation can consist in the known manner of polystyrene, preferably in the form of an expanded (EPS), particle or structural foam, which has excellent thermal insulation properties.

All self-adhesive areas on the sheets in accordance with the invention can be thermally activated self-adhesive areas, or cold self-adhesive areas, so as to allow laying in any weather and substrate conditions.

The (polymer) bitumen of the sheets in accordance with the invention can contain conventional inclusions and reinforcements, selected, for example, from aluminium foils, fibreglass, glass screens, glass fibre mats, plastic mats and combinations thereof, in order to provide the sheets with increased rigidity and resistance to breaking, tearing and impact and thereby protect them from damage.

Despite self-adhesive surfaces possibly being provided on both sides, all sealing and/or insulating sheets in accordance with the invention can, until they are used, come rolled up on themselves in the form a roll, as each adhesive surface is provided with protective coverings in the form of conventional separating materials, such as, for example, separating foils or separating paper. Embodiments of the invention with thermal insulation are stored as prefabricated rolled or folded sheets.

When laying particularly preferred sheets in accordance with the invention, the self-adhesive areas of two overlapping sheets are stuck together so that a homogeneous interface is formed and better adhesion as well as greater adhesion durability result (e.g. in relation to the tightness of the adhesive interface). In this way it becomes possible to achieve adequate adhesion (immediately or, if necessary, by way of re-adhesion through increasing the temperature) at lower temperatures than the hitherto usual range of normally 5-10° C., which also makes laying the sheets at less than 5° C. possible.

In addition, the self-adhesive areas on the upper side of the sheets remain protected by the remainder of the protective covering(s) until the next layer is applied, which dispenses with costly cleaning and drying of the layer surface, thereby considerably reducing the time and costs required for covering roofs and lining the external walls of cellar, for example.

The present invention will be described in more detail below with reference to the attached drawings.

FIG. 1a shows a schematic cross-section of a simple form of embodiment of the sealing and/or insulating sheet in accordance with the invention, with a self-adhesive area and protective covering over the entire upper surface area, and with surface modification of the (polymer) bitumen on the underside;

FIG. 1b shows a schematic cross-section of the structure of a further form of embodiment of a sealing and/or insulating sheet in accordance with the invention, with a self-adhesive area and protective covering over the entire upper surface area, and with self-adhesive areas and protective coverings on the longitudinal edges on the underside;

FIG. 1c shows a schematic cross-section of a further form of embodiment of a sealing and/or insulating sheet in accordance with the invention, with self-adhesive areas and protective coverings completely covering both sides;

FIG. 2a shows a schematic partial side view of the underside of the sealing and/or insulating sheet in FIG. 1c, with partially lifted protective covering;

FIG. 2b shows a schematic partial side view of the upper sides of the embodiments of the sealing and insulting sheets in FIG. 1 with the perforations and/or slits and/or weaknesses in the protective covering;

FIG. 3a shows a similar isometric partial view as in FIG. 2b, in which, however, the perforations and/or slits and/or weaknesses are provided at regular intervals over the entire width of the sheet;

FIG. 3b shows a schematic isometric partial view of the underside of the sealing and/or insulating sheet in FIG. 1b;

FIG. 4a shows a schematic isometric partial view of a form of embodiment of the sealing and/or insulating sheets in accordance with the invention with several removed protective covering strips;

FIG. 4b shows a schematic isometric partial view of the overlapped laying of two sealing and/or insulating sheets in accordance with the invention in FIG. 4a;

FIG. 5 shows a schematic cross-section of the arrangement of several sealing and/or insulating sheets in accordance with the invention after overlapping laying on a substrate;

FIG. 6 shows a schematic cross-section of several overlapping protective coverings on the self-adhesive surface of a sealing and/or insulating sheet in accordance with the invention;

FIG. 7a shows an isometric partial view of a form of embodiment of the invention with slits and/or perforations and/or weaknesses in a lateral direction close to one lateral edge of a sealing and/or insulating sheet in accordance with the invention;

FIG. 7b shows the embodiment in FIG. 7a with thermal insulation elements additionally provided on the underside;

FIG. 8a shows a longitudinal cross-section of the form of embodiment in FIG. 7b;

FIG. 8b shows a variant of the form of embodiment in FIGS. 7b and 8a with just two thermal insulation elements provided on the underside;

FIG. 8c shows the form of embodiment in FIG. 8b folded for storage (“folded sheet”); and

FIG. 9 shows a schematic cross-section of two sealing and/or insulating sheets in accordance with the invention with projecting safety strips after overlapped laying on a substrate.

### MORE DETAILED DESCRIPTION OF THE FIGURES

FIG. 1 shows three schematic (i.e. not to scale) lateral cross sections of sealing and/or insulating sheets 1 in accordance with the invention. FIG. 1a shows a sealing and/or insulating sheet 1 made of conventional (polymer) bitumen as the basic material, which on the entire upper side is provided with a self-adhesive surface 2 consisting of a conventionally used adhesive (e.g. bitumen SBS blends plus additives) with a layer thickness, which is normally in the range of tenths of millimetres. The (polymer) bitumen can, as mentioned in the introduction, contain various inclusions or reinforcements (not illustrated), e.g. aluminium foil, glass fabric, glass screens, glass mats, plastic mats and combinations thereof.

It general it can be stated that in the figures shown here, the self-adhesive surfaces of the sheets 1 in accordance with the invention are normally (at least) provided on the upper side, as shown by the preferred embodiment of the invention, as in this way laying of the next layer of sheets on top can take place without costly cleaning and drying of the surfaces. The protective covering 3 only has to be pulled off, whereupon the dry and clean self-adhesive surface 2 is made available. Some areas of application of the sheets in accordance with the invention may, however, require only the underside to be provided with a self-adhesive surface 2, so that the reverse construction also lies within the protective scope of the invention. The advantage of partial removal of the protective coverings along slits, perforations and/or overlaps of individual protective covering sheets is present in each case.

The self-adhesive surface 2 of the sheet 1 is protected against damage, dirt and moisture with a protective covering 3 in the form of a separating layer sheet made, for example, of (possibly silicon-treated) separating paper, plastic separating film or other conventionally used easily removable materials (for example also reinforcements made of glass of plastic fabric). In the vicinity of the two longitudinal edges, as well as in the centre of the sheet, the protective covering has slits and/or perforations and/or weaknesses 4, along which the protective covering 3 can pulled off when laying the sheet(s) 1.

Hereinafter, the term weaknesses is taken to mean both those that are already provided in the protective covering 3 during the production of the sheets, i.e. before their use, for example through folding, stamping or punching the covering film, as well as those that are only produced shortly before or during the laying of the sheets 1 in accordance with the invention. Here, for example, a thread (or narrow band) of, for example, tear-resistant plastic or metal or metal-plastic composite material or suchlike, which is incorporated into the protective covering 3 during the production thereof, is pulled out in order to provide a “weakness” line at the appropriate point in the protective covering 2, which then represents a connection that can be easily detached by operating personnel when laying the sheets 1, while during storage unintentional removal of parts of the protective covering is not possible.

Both forms of the embodiment are covered by the term “weakness” within the context of the present invention.

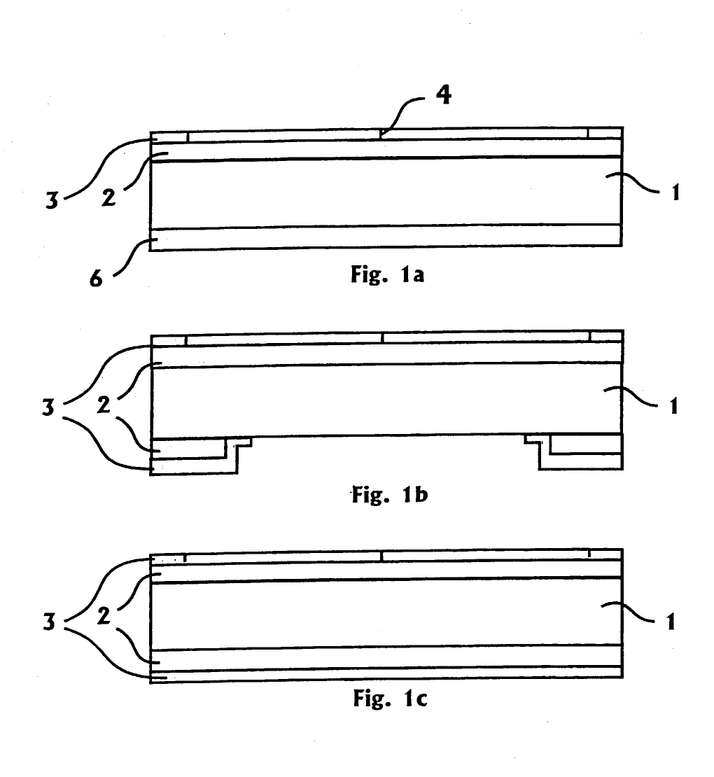

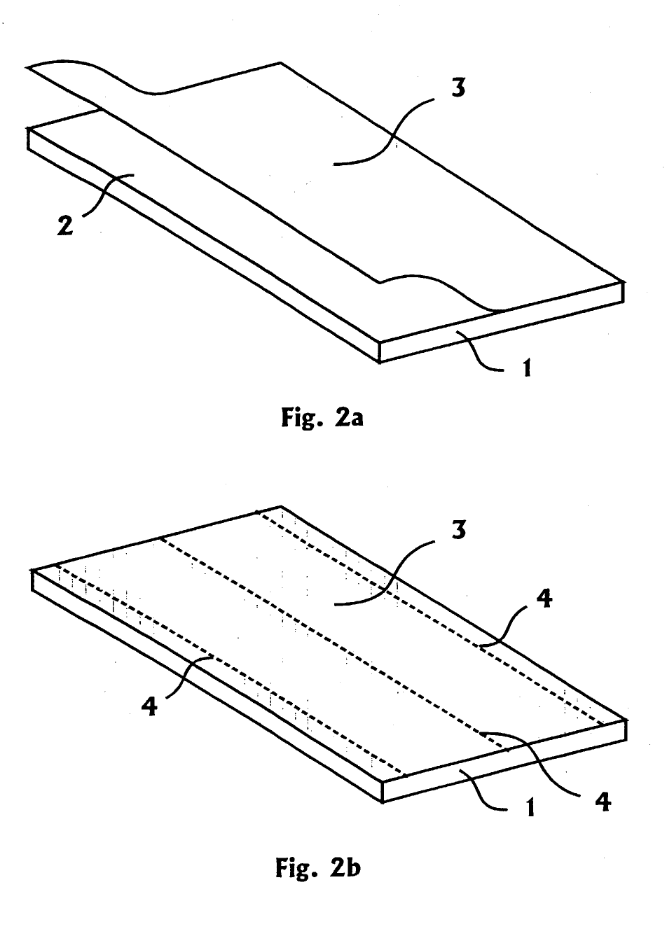

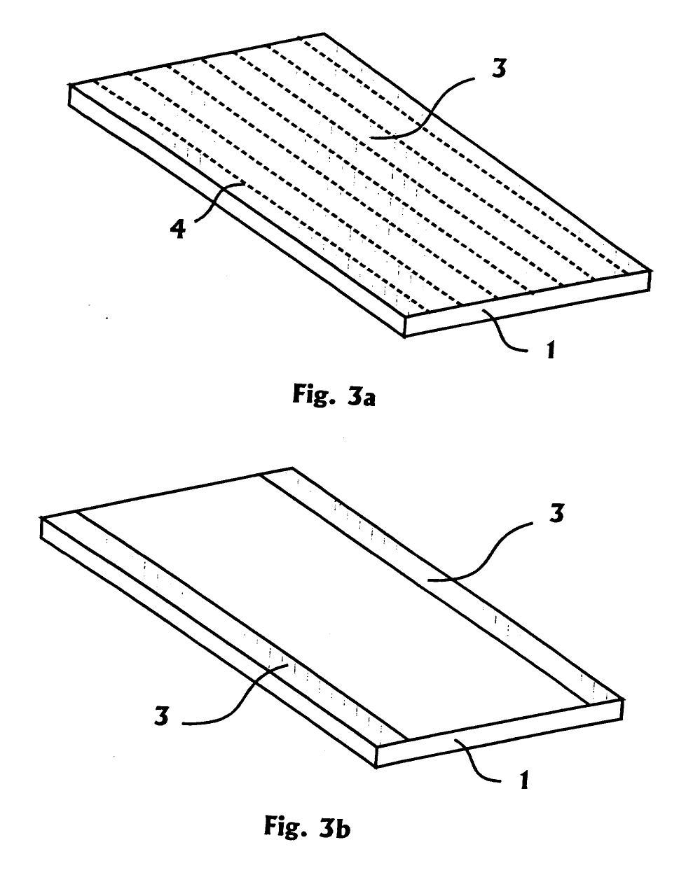

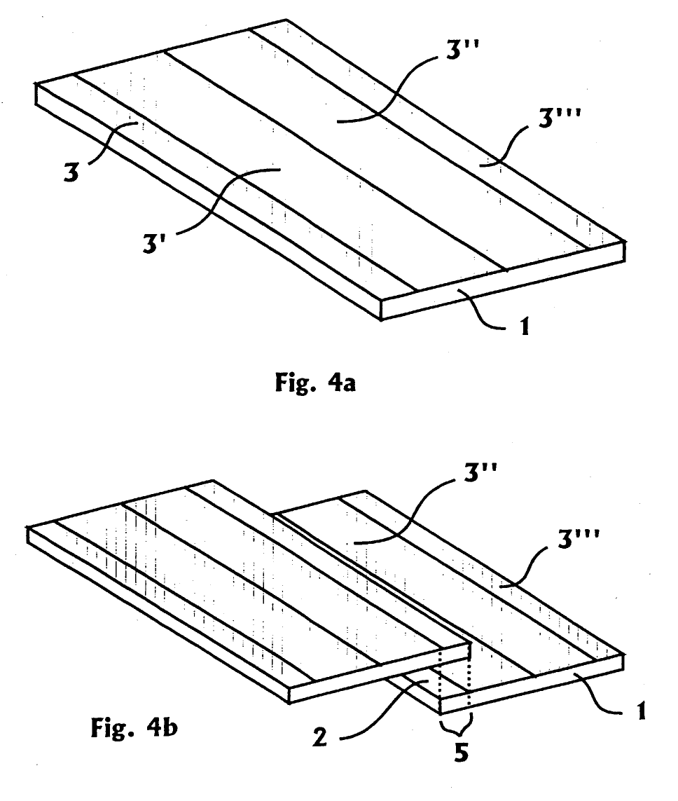

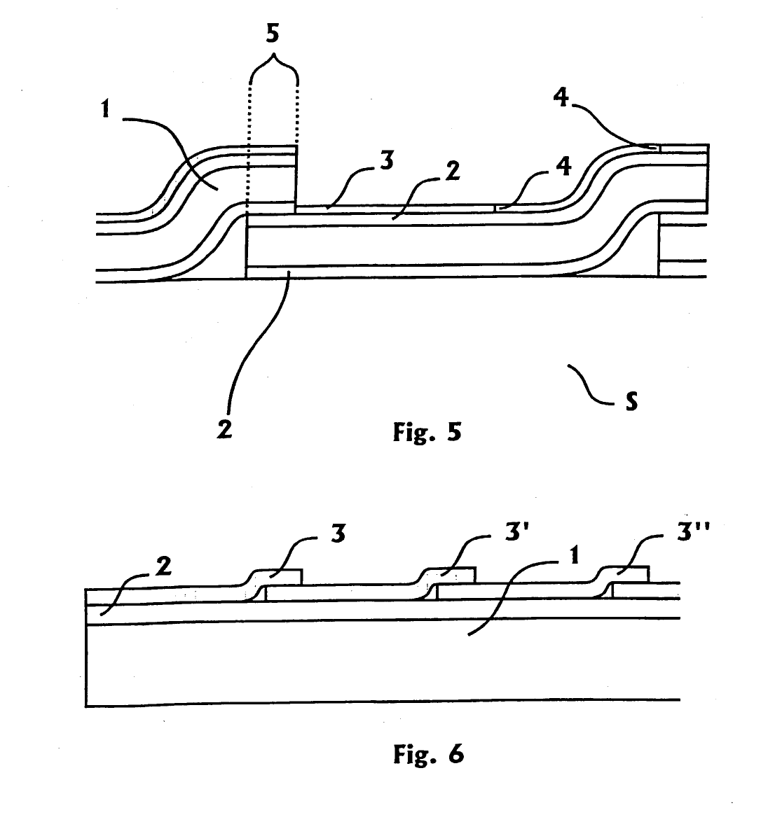

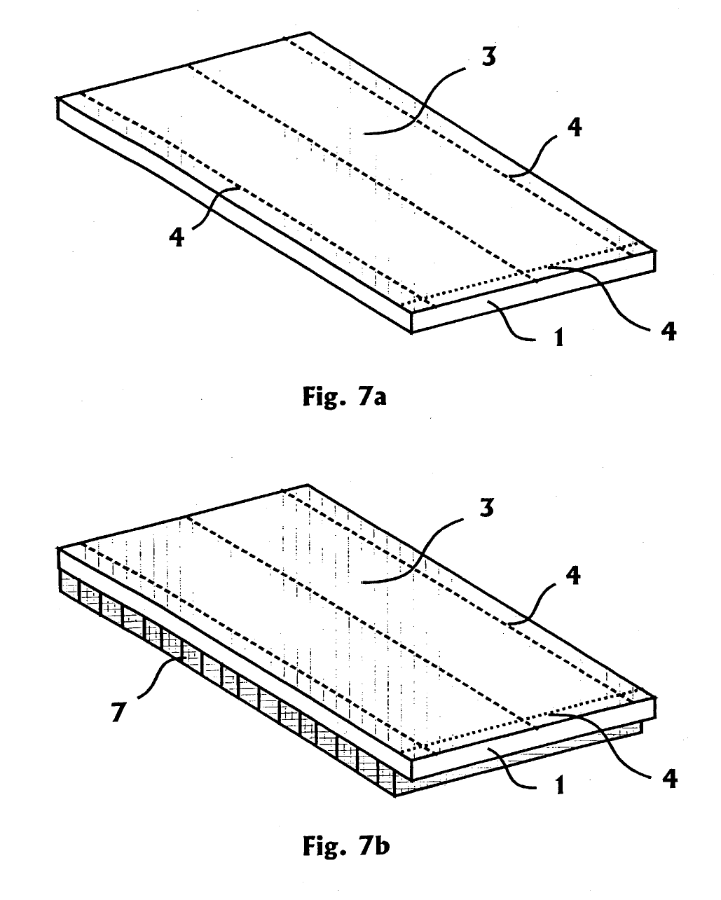

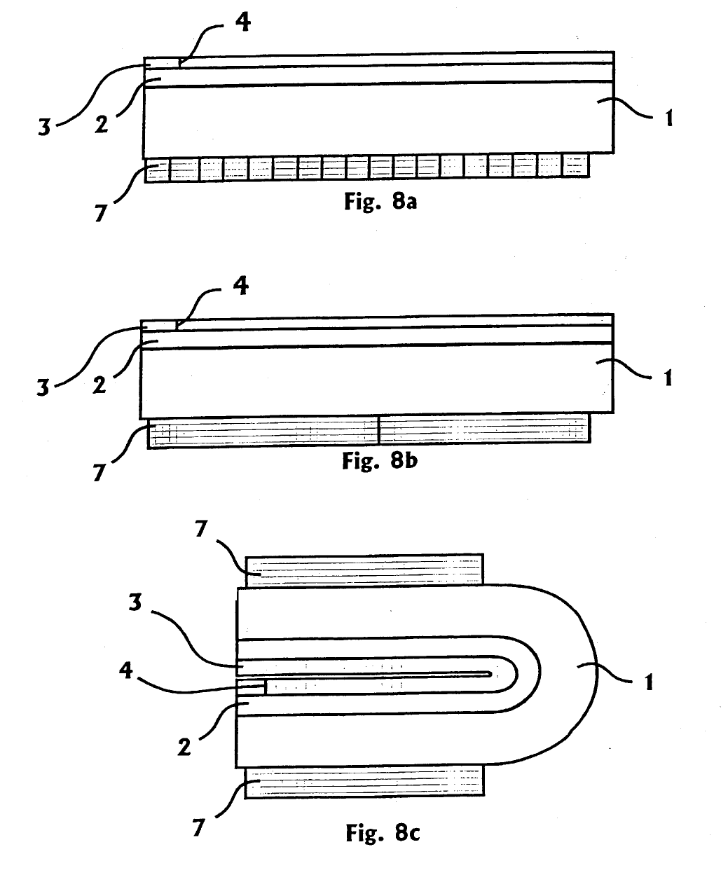

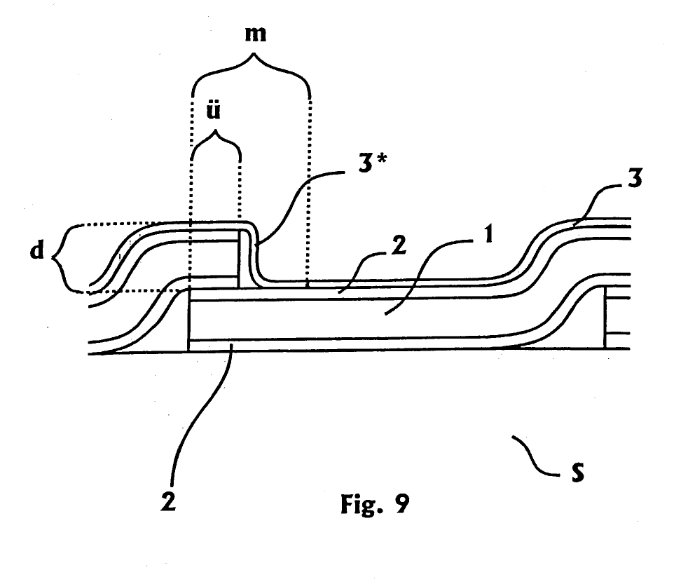

The underside of the sheet 1 in accordance with the invention is provided with a surface modification 6 in FIG. 1a, which in addition to having a slight protective effect, is primarily intended to prevent the bitumen, which is adhesive at normal or increased temperature, from adhering within the roll. Conventionally, non-detachable films (which after laying the sheet either remain unchanged, or are burned off or melted during flaming), natural slate, coloured sand particles, fine sand and talcum are used as such surface modifications. The invention is not, however, restricted to these examples.

The length and width of the sheets 1 in accordance with the invention are not specially restricted. A width of 1 m is normal. The length varies with the thickness of the sheet (normally 2 to 5 mm thick), but generally lies in a range of 3 to 20 m, preferably 5 to 10 m, in length. For prefabricated elements in the form of rolled sheets and folded sheets comprising thermal insulation and initial layer (polymer) bitumen sheet 1, the length is, more particularly, 3 to 5 m. Such sheets will be described in more detail at a later stage.

FIG. 1b shows a modification of the sealing and/or insulating sheet 1 in accordance with the invention in which on the underside the longitudinal edges of the sheet 1 are provided on both sides with strip-like self-adhesive surfaces 2, which in turn are covered with protective coverings 3 that are also in the form of strips. When laying such sheets, mutual adhesion of the sheets in one layer take place at the edge, i.e. at the points where the sheets in one layer overlap.

In FIG. 1b the distances between the slits and/or perforations and/or weaknesses 4 on the upper side and the longitudinal edge is less in than the width of the self-adhesive surfaces 2 on the underside. The effect of this is that the latter, when laying such sheets, do not only adhere to the self-adhesive surface on the upper side of the previously laid sheets in a layer up to the slit and/or perforation and/or weakness 4 (after removal of the upper and lower protective coverings in this area), but also to the substrate. By way of selecting a distance between the slit and/or perforation and/or weakness 4 and the longitudinal edge that corresponds to the width of the self-adhesive surface on the underside, homogeneous adhesive interfaces are exclusively formed. In both cases two adhesive surfaces are brought into adhesive contact with each other, where, instead of the usual adhesion forces, cohesion forces come into play, which makes much stronger and durable adhesion possible.

FIG. 1c shows a variant of the form of embodiment in FIG. 1b, in which the sheet 1 is provided with self-adhesive surfaces 2 over the entire area of upper and lower sides, which permits adhesion of the sheet 1 to the substrate without extreme heating.

Such forms of embodiment of the sheets 1 in accordance with the invention can be used separately or in combination when laying a layer during the course of roof covering or lining the external walls of cellars. This means that a layer can consist exclusively of layers of one type, or, for example, different layers can be laid alternately, whereby the substrate adhesion can be improved compared to the sole use of sheets in FIG. 1a and the material consumption of adhesive and separating material can be reduced compared the sole use of sheets in accordance with FIG. 1c, which thereby also reduces the costs.

Before use, the sheets are normally stored rolled up on a roll, which, due to the protective coverings 3 applied on both sides, is also possible in the case of the sealing and/or insulating sheets 1 in accordance with the invention provided with self-adhesive surfaces 2 on both sides, and is also preferable as of a certain length, as the sheets are easy to lay from such rolls.

Such more efficient and stronger adhesion of the sheets 1 provided with self-adhesive surfaces 2 on both sides also permits the use, i.e. the laying, of the sealing and/or insulating sheets in accordance with the invention at lower temperatures, i.e. temperatures at which the adhesion forces in accordance with the state of the art are not sufficient to produce strong adhesive bonds. The limit for this is normally a minimum of 5° C. With sheets in accordance with the invention, laying at below 5° C. is also possible without problems. The lower limit varies depending on the adhesive used, but in the case of two cold self-adhesive surfaces is around −3° C. to 0° C.

In general a distinction is made between hot melt-type adhesive, hot self-adhesive and cold self-adhesive surfaces. Adhesive through thermal activation is, for example, the (polymer) bitumen, as the principal component of the sheet, for which large amounts of heat have to be provided. However, the advantage lies in the fact that such thermally activated adhesive surfaces also adhere very well to substrates such as concrete and masonry (with primer). Hot self-adhesive surfaces are provided with an adhesive (e.g. bitumen SBS blend plus additives) which is not adhesive at normal temperature, but becomes self-adhesive with the addition of small amounts of thermal energy, for which, depending on the-adhesive mixture, solar radiation can suffice. Finally, cold self-adhesive surfaces are adhesive over a wide temperature range without any additional heating. A lower limit of around 5° C. is usual, which, however, can be reduced in accordance with the invention to below 0° C. though the homogeneous bonding of two such cold self-adhesive surfaces.

FIG. 2a shows the underside of the form of embodiment in FIG. 1c with a full self-adhesive surface 2 and accompanying, partially raised, protective covering 3 without slits and/or perforations and/or points of weakness 4, which in this embodiment are only provided on the upper side. FIG. 2b show an isometric partial view of the upper side of the sheets 1 in FIGS. 1a-1c (the ratio between the length and width of the sheets is normally much larger). The protective covering is slit and/or perforated and/or provided with weak points at three points 4 over the entire length of the sheet. Two of the slits and/or perforations and/or weak points are in the vicinity of the two longitudinal edges, and the third is in the centre of the sheet. The underside of the sheets shown here can in turn be designed in any manner, i.e. with fully or only partially provided protective coverings 3, or made of surface-modified (polymer) bitumen.

The advantage of the protective coverings 3 being divided in accordance with the invention consists in the fact that the surface not directly required for producing adhesive bonds with other sheets 1 in the same layer, remains covered and protected by the protective covering 3 until the next layer of the roof covering or wall lining is applied. This dispenses with the costly cleaning and drying of the surfaces of already laid sheets, which in accordance with the state of the art are exposed, before applying the next layer, which represents a considerable saving in terms of time and costs.

The division of the protective covering 3 contains the following further advantage: the laying of sealing and/or insulating sheets takes place with the longitudinal edge overlapping each other, so that within a layer only one edge section of the protective covering 3 needs to be removed when laying the sheets 1. In order not to be restricted to a particular laying direction, both edges are slit and/or perforated and/or provided with weak points. The remainder of the protective covering remains on the surface until the next layer is applied.

If, with the first layer of sheets the edge of the substrate is reached, i.e. for example of the roof or the cellar wall, the projecting part of the last sheet must be cut off in a longitudinal direction, whereby the protective covering frequently tears or is—at least partially—unintentionally pulled off. By providing slits and/or perforations and/or weak points, even in the centre of the sheet, this is prevented as separation can take place along this slit and/or perforation and/or weak point and the separated projecting section can be re-used as the adhesive surface is still protected with protective covering.

A particularly preferred form of embodiment of the sealing and/or insulating sheet 1 in accordance with the invention is therefore shown in FIG. 3a, in which slits and/or perforations and/or weaknesses 4 are provided at regular intervals over the entire width of the sheet 1, which guarantees greatly increased variability when laying the sheet—both in terms of the width of the overlaps and removing the aforementioned projecting sections at the edge of the substrate. The distance between the slits and/or perforations and/or weaknesses 4 can be selected between 1 and 20 cm, preferably 2-10 cm.

The width of the overlaps between the sheets 1, which is normally 5-12 cm, can therefore be highly variably selected without having to pull off entirely, or manually cut the protective covering 3. In addition, efficient re-use of the removed projecting sections at the substrate edges is made possible.

The slit and/or perforation and/or weakness 4 in the centre of the sheets 1 also has the advantage that when the next layer of sheets is applied, the entire protective covering 3 does not have to be pulled off again. Laying of the next layer of sheets also takes place in an overlapping manner, though not overlapping by the same width so as not to produce very thick points due to several overlaps on top of each other on a roof or cellar wall lining, and in order not to concentrate critical adhesion and tightness points in one line. Therefore, all subsequent sheets are normally laid offset by half a sheet width. In accordance with the invention, the protective covering can then again be removed along the provided slits and/or perforation and/or weaknesses 4.

FIG. 3b is an isometric partial view of the underside of the form of embodiment in FIG. 1b in which self-adhesive surfaces 2 and protective coverings 3 are only provided on the longitudinal edges, which, as has been stated above, saves material and costs. The upper side, which is not shown in FIG. 3b, is provided with a self-adhesive surface 2 and protective covering 3 over its entire area.

FIG. 4a shows a variant of the sealing and/or insulating sheet 1 in accordance with the invention in FIG. 2b, in which the protective covering 3 is not divided by cuts or perforations or weaknesses 4, but by way of individually partially overlapping protective covering sheets. In FIG. 4a there are four individual sheets, 3, 3′, 3″ and 3′″.

A schematic cross section of the arrangement of these individual sheets 3, 3′, 3″, 3′″ of protective covering on the self-adhesive surface of a sheet 1 is shown in FIG. 6. The advantage of this form of embodiment over the forms divided by cuts or perforations or weaknesses 4 is that in the case of the latter forms of embodiment, dirt or moisture may possibly penetrate through the cuts or perforations 4, which is effectively prevented by the partial overlapping of the protective coverings. Weaknesses, irrespective of whether they have been previously stamped or punched or are only produced on site by pulling out a thread or band, also provide better protection against dirt and moisture.

Preferably the partial overlapping of the individual sheets of the protective covering originates from the edges of the sheet 1, i.e. the outermost individual sheets of the protective covering, sheets 3, 3′″ in FIG. 4a, partially lie above the ones located on the inside (3′, 3″), so as not to be restricted to one particular laying direction.

FIG. 4b clearly shows in schematic manner how sheets 1 in accordance with FIG. 4a come to lie on top of each other during laying. Part of the protective covering, i.e. individual sheet 3 in FIG. 4a, has been removed so that the self-adhesive surface 2 is exposed in the area of the longitudinal edge. Stuck onto this in an overlapping manner is another sheet 1, from which any protective coverings have already been removed from the underside (not illustrated). The width of the overlap 5 (indicated by the broken line in the figure), corresponds to the smallest distance between the partial overlap of the protective covering sheets and the edge of the sheet 1, in FIG. 4 the distance between the partial overlap of 3 on 3′ and the edge.

FIG. 5 shows an arrangement of the sheets 1 in accordance with the invention after laying. They overlap by the width indicated by 5. In this area 5 the protective covering 3 has been removed from the upper side of each sheet 1, so that there is direct adhesion between two self-adhesive surfaces 2, i.e. a cohesive bond. The protective covering on the underside of each sheet 1 has been fully removed, which allows full-area contact between the substrate 5 and a self-adhesive surface 2 of each sheet 1. The intermediate space between the individual sheets seen in the drawing must not of course occur in practice, though it hardly occurs due to the small thickness of the sheets (a few mm), and can be easily avoided entirely if care is taken during laying.

On the upper side of sheets 1 forming a layer, the protective covering 3 is still present except in the overlap area, so that self-adhesive surface 2 on the upper side remains protected against dirt and moisture until the next layer of sheets is applied through adhesion.

The process of laying preferred sealing and/or insulating sheets in accordance with the invention can be best described with the aid of FIG. 5. Over the entire area of both surfaces, particularly preferred sealing and/or insulating sheets 1 in accordance with the invention have self-adhesive surfaces 2 with protective coverings 3 lying on top of them, which at several points 4, more particularly at regular intervals over the entire width of the sheets, are slit and/or perforated and/or weakened and/or designed in the form of several overlapping separating layer sheets (3, 3′, 3″, 3′″).

The laying of such sheets on a substrate, such as, for example, a roof or on an external wall of a cellar, takes place as follows in accordance with the invention (from right to left in FIG. 5).

In accordance with the technical rules, the first sheet 1 is placed or stuck on the substrate 5 at the lowest point, with any protective covering(s) 3 being removed from the underside of the sheet 1, i.e. the side facing the substrate (S) while the sheet 1 is slowly unrolled onto the substrate. A second sheet 1 is then placed or stuck onto the substrate S, with the first and second sheet partially overlapping along their longitudinal edges 5. In doing so any protective covering(s) 3 are again removed from the underside of the second sheet, and at the same time as unrolling the second sheet, the protective covering 3 of the first sheet is removed in the area of the overlap 5 along an appropriate perforation and/or weakness (possibly after previously having produced the weakness by pulling out an incorporated thread or band) and/or an appropriate slit 4 and/or one or more separate separating layer sheets (3, 3′″), in order to expose the self-adhesive surfaces 2 of both sheets in the overlap area 5 and to stick them homogeneously to each other by way of cohesion forces.

The third and all further sheets are then stuck onto the substrate S and, in the area of the overlap 5, one after the other onto each preceding sheet in the same way described above, until the substrate has attained the required degree of covering with sheets 1—normally until it is completely covered. Finally, the last sheet, which projects beyond the edge of the substrate, is cut to size, which in accordance with the invention can preferably be done along a cut and/or a perforation and/or weakness 4 and/or a partial overlap of the protective coverings 3, 3′, 3″, 3′″. This cut-off excess is still provided with protective covering and can, if required, be used for the next layer, possibly as a sheet lying on the edge, without having to cut an entire sheet 1.

FIG. 6 shows, as has already been stated, the arrangement of individual partially overlapping protective covering sheets 3, 3′, 3″, 3′″ on a self-adhesive surface of a sheet 1 in accordance with the invention, whereby the partial overlapping takes place in the opposite direction on the second half of the sheet 1 (not shown), so as not to be restricted to one particular laying direction.

FIG. 7a shows a variant of the sheet in FIG. 2b in accordance with the invention, in which in addition to the cuts and/or perforations and/or weaknesses 4 in the longitudinal direction, a further cut and/or perforation and/or weakness 4 is provided in the lateral direction close to the lateral edge of the sheet 1. This additional cut and/or perforation and/or weakness 4 is intended for overlapping in the event of “abutment” when laying the sheets. Abutment is taken to mean bringing two sheets into contact with each other at their lateral edges, which is necessary, for example, in cases where the substrate to be covered is wider than the length of the sheet(s). In the event of abutment, the sheets are also laid in an overlapping manner, which, in accordance with the invention, is facilitated by cuts and/or perforations and/or weaknesses 4, or also partially overlapping individual sheets of protective covering, in a manner analogue to that described above.

FIG. 7b in turn shows a schematic isometric partial view of a further particularly preferred form of embodiment of sealing and/or insulating sheets in accordance with the invention, in which thermal insulation elements 7 are provided on the underside of a sheet 1 in accordance with FIG. 7a. These extend at regular intervals in a lateral direction and adhere to or are melted onto the underside of the sheet 1.

The thermal insulation 7 normally consists of conventional polystyrene, preferably in the form of an expanded (EPS) particle or structural foam, as has long been used for the thermal insulation of buildings. However, any other material that is suitable for this purpose can be used as long as the advantages of the invention, i.e. simplifying laying, are preserved.

FIG. 8a shows a longitudinal section of the form of embodiment in FIG. 7b. Such sheets 1 provided with thermal insulation 7 make further time and cost reductions possible when covering roofs and lining the external walls of cellars, as two layers, namely thermal insulation and the next sealing layer, can be laid at the same time. The storage and transportation of these sheets normally takes place in the form of “rolled sheets”, i.e. also rolled up into a roll, in which the thermal insulation normal faces outwards. However, by setting regular intervals between the thermal insulation elements 7, inverse rolling up is also possible.

A variant of these rolled sheets is shown in FIG. 8b, where a sheet 1 with a self-adhesive surface 2, protective covering 3 and slit and/or perforation and/or weakness 4 for abutment on the upper surface, is provided on the lower surface with just two more compact thermal insulation elements 7. Such sheets are normally shorter that rolled sheets (only around 2-3 m) and are stored folded in the form of “folded sheets” as shown in FIG. 8c.

Finally, FIG. 9 shows a particularly preferred form of embodiment of the invention in cross section, whereby at least one of the protective coverings located on the edge projects beyond this edge, more particularly over its entire length, in order to form a safety strip 3*. In FIG. 9—in an analogue manner to FIG. 5—the overlapping laying of such sheets is shown. The direction of laying in this drawing is again from right to left, and laying takes place as described in connection with FIG. 5. However, in this form of embodiment, each sheet is not stuck over its entire area onto the self-adhesive area m exposed by removing the edge section of the protective covering 3 of the previous sheet (along a division, which is not shown, i.e. cut, perforation, weakness or partial overlap), but is slightly offset towards the (left) edge, so that along the overlap u“a strip of self-adhesive surface (m−ü) is not covered by the underside of the following sheet. The projecting safety strip 3* of each sheet is now bent down over its edge and stuck onto this exposed self-adhesive surface 2 so that the (vertical) side of the sheet, and consequently the entire surface of all the sheets, remains protected with protective covering 3 before the next layer is applied.

By way of such safety strips the hitherto exposed side faces of the sheets can remain protected from dirt and moisture during laying of the sheets 1 in accordance with the invention. Preferably, the width b of the safety strip 3* thereby corresponds at least to this exposed self-adhesive surface plus the thickness d of the sheet, as shown by the following equation:

b≧d+(m−ü)

where:

b: Thickness of the safety strip 3*

d: Thickness of the sheet 1

m: Minimum distance between the next slit and/or perforation 4 or partial overlap of individual separating layer sheets and the edge

ü Width of the overlap 5 of the sheets during laying

If b is greater than the sum of d+(m−ü), similar partial overlaps, as shown in FIG. 6, are formed by the safety strips 3*, which in turn additionally covers and protects the abutment between the protective coverings 3 of two overlapping sheets. This variant therefore represents a particularly preferred form of embodiment of the invention.

The present invention cannot only be used for the types of sealing and/or insulating sheets described above, but in principal for all those used, for example, in roof covering and insulating the external walls of cellars, even the sheets used for the uppermost layer of roof coverings, if at least one other covering (e.g. flooring, roof garden base etc) follows.

It is self-evident that even though the invention has been described with reference to specific examples, numerous modifications can be made to it, which also lie within the protective scope of the invention.

1. A sealing and/or insulating sheet made of (polymer) bitumen, more particularly for covering roofs and lining the external walls of cellars, with at least one self-adhesive surface consisting of adhesive material provided on at least one part of one of the surfaces of the sheet, whereby the, or each, self-adhesive surface is provided with a detachable protective covering,
characterised in that the protective covering (3) of at least one self-adhesive surface (2) is, at one or more points (4), slit and/or perforated and/or weakened and/or designed in the form of several partially overlapping separating layer sheets (3, 3′, 3″, 3′″), whereby parts of the protective covering (3) can be removed independently of each other along predefined lines.

2. The sealing and/or insulating sheet according to claim 1, characterised in that one surface of the sheet (1) is provided in its entirety with a self-adhesive surface (2) and a protective covering (3).

3. The sealing and/or insulating sheet according to claim 2, characterised in that at regular intervals over the entire width of the sheet (1), the protective covering (3) is longitudinally slit and/or perforated and/or weakened and/or designed in the form of several partially overlapping separating layer sheets (3, 3′, 3″, 3′″).

4. The sealing and/or insulating sheet according to any one of claims 1 to 3, characterised in that in the vicinity of at least one lateral edge of the sheet (1), the protective coverings (3) are also laterally slit and/or perforated and/or weakened and/or designed in the form of a partially overlapping separating layer sheet (3′″).

5. The sealing and/or insulating sheet according to any one of the preceding claims, characterised in that the minimum distance between the slits and/or perforations and/or weaknesses (4) and/or partial overlaps of individual separating layer sheets (3. 3′, 3″, 3′″) and the nearest edge of the sheet (1), corresponds to the width of the overlaps (5) formed when laying the sheets.

6. The sealing and/or insulating sheet according to any one of claims 1 to 4, characterised in that at least one of the protective coverings (3, 3′, 3″, 3′″) located at the edge, projects beyond this edge, preferably over its entire length, so as to form a safety strip (3*).

7. The sealing and/or insulating sheet according to claim 6, characterised in that the width of the safety strip (3*) satisfies the following equation:
b≧d+(m−ü)
where:
b: Thickness of the safety strip
d: Thickness of the sheet
m: Minimum distance between the next slit and/or perforation or partial overlap of individual separating layer sheets and the edge
ü Width of the overlap (5) of the sheets during laying

8. The sealing and/or insulating sheet according to any one of the preceding claims, characterised in that on at last one part of the opposite surface of the sheet (1), at least one self-adhesive surface (2), including accompanying protective covering(s) (3) is provided.

9. The sealing and/or insulating sheet according to any one of the preceding claims, characterised in that the adhesive material of the self-adhesive surface(s) (2) on one surface of the sheet (1) is the same as that of the self-adhesive surface(s) (2) on the opposite surface of the sheet (1).

10. The sealing and/or insulating sheet according to claim 8 or 9, characterised in that the protective covering(s) (3) on the self-adhesive surfaces(s) (2) on the opposite surface of the sheet (1) is/are defined as in any one of claims 1 to 7.

11. The sealing and/or insulating sheet according to any one of the preceding claims, characterised in that one or more surface modifications(s) (6) is/are provided on at least one part of the opposite surface of the sheet (1).

12. The sealing and/or insulating sheet according to claim 11, characterised in that the surface modification(s) (6) is/are selected from among non-detachable foils, natural slate, coloured sand particles, fine sand and talcum.

13. The sealing and/or insulating sheet according to any one of the preceding claims, characterised in that at least part of the opposite surface of the sheet (1) is provided with thermal insulation (7), preferably attached through adhesion or melting.

14. The sealing and/or insulating sheet according to claim 13, characterised in that the thermal insulation consists of polystyrene, preferably in the form of an expanded (EPS) particle or structural foam.

15. The sealing and/or insulating sheet according to any one of the preceding claims, characterised in that the self-adhesive surfaces (2) are thermally activated self-adhesive surfaces.

16. The sealing and/or insulating sheet according to any one of the preceding claims, characterised in that the self-adhesive surfaces (2) are cold self-adhesive surfaces.

17. The sealing and/or insulating sheet according to any one of the preceding claims, characterised in that the (polymer) bitumen contains inclusion and/or reinforcements.

18. The sealing and/or insulating sheet according to any one of the preceding claims, characterised in that the inclusions and/or reinforcement are selected from among aluminium foils, glass fabrics, glass screens, glass mats, plastic mats and combinations thereof.

19. The sealing and/or insulating sheet according to any one of the preceding claims, characterised in that the sheet (1) comes rolled up into a roll until it is used.

20. The sealing and/or insulating sheet according to claim 13 or 14, characterised in that the sheet (1) comes in the form of a rolled sheet or folded sheet until it is used.

21. The sealing and/or insulating sheet according to any one of the preceding claims, characterised in that weaknesses in the protective covering (3) are provided at the appropriate points through folding, stamping or punching, or can be provided through pulling out threads or bands, made, for example, of plastic, metal or composite material, which are incorporated into the protective covering (3) there.
